(19) United States
(12) Patent Application Publication
(10) Pub. No.: US 2011/0255972 A1
(43) Pub. Date: Oct. 20, 2011

(54) MULTI-ELEMENT WIND TURBINE AIRFOILS AND WIND TURBINES INCORPORATING THE SAME

(75) Inventor: Paul Lew, Las Vegas, NV (US)

(73) Assignee: GIFT TECHNOLOGIES, LLC, Harbor City, CA (US)

(21) Appl. No.: 13/083,315

(22) Filed: Apr. 8, 2011

Related U.S. Application Data
(60) Provisional application No. 61/322,783, filed on Apr. 9, 2010.
(60) Provisional application No. 61/342,327, filed on Apr. 12, 2010.

(51) Int. Cl. F03D 3/00

(52) U.S. Cl. 416/111

(57) ABSTRACT

The present invention relates to wind turbines and more particularly to a multi-element airfoil for a vertical or horizontal axis wind turbine. In one embodiment, a vertical wind turbine includes a plurality of blades arranged in an annular path around a central axis of rotation. Each blade includes a first element and a second element that are nestable together. The first element has a concave rear surface, and the second element has a convex leading surface. Each of at least 45% of the blades generates a lift in a direction of rotation of the turbine that is greater than a drag generated by the same blade.

### CROSS-REFERENCE TO RELATED APPLICATIONS

This application claims priority to and the benefit of U.S. Provisional Application No. 61/322,783, filed Apr. 9, 2010, and U.S. Provisional Application No. 61/342,327, filed Apr. 12, 2010, the entire contents of both of which are expressly incorporated herein by reference.

### FIELD OF THE INVENTION

The present invention relates to wind turbines and more particularly to a multi-element airfoil for a vertical or horizontal axis wind turbine.

### BACKGROUND OF THE INVENTION

Vertical wind turbines and horizontal wind turbines are used to convert wind energy into electric energy. Vertical wind turbines include a plurality of vertical airfoils, i.e., blades, arranged in parallel around a rotor. The blades rotate about a vertical axis. It should be noted that the terms “blade” and “airfoil” are used interchangeably herein. Horizontal wind turbines include of a plurality of blades extending radially from a hub in a vertical plane, much like a fan. In horizontal wind turbines, the blades rotate about a horizontal axis.

Many current wind turbines operate with relatively low efficiency. For example, a vertical wind turbine 100 includes a plurality of blades rotating about a vertical axis A. As the blades rotate, the blades located in arc 35 of typically 140° or more generate insufficient lift or no lift in the direction of rotation to overcome the drag generated by these blades (see FIG. 8). Insufficient lift is lift generated by a blade that is not sufficient to overcome the drag by the same blade. Thus, the blades located in this arc 35 tend to slow the rotation of the wind turbine and thus reduce the efficiency of the wind turbine. Typically, the arc 35 includes blades located about 20° away from the wind in one direction and about 120° away from the wind in the other direction. Data relating to such blades and the lift generated by such blades is shown in Appendix A of the related provisional application, No. 61/322,783. Appendix A from that application is incorporated herein by reference.

Wind turbines which have a better efficiency such that they can generate more electrical energy for a given wind condition are desired.

### SUMMARY OF THE INVENTION

The present invention relates to wind turbines and more particularly to a multi-element airfoil for a vertical or horizontal axis wind turbine. In one embodiment, a vertical axis wind turbine is provided with a plurality of multi-element blades arranged annularly around a vertical axis. Each blade includes three blade elements, a leading element, an intermediate element, and a trailing element. The leading and intermediate elements include mating convex and concave surfaces such that the two elements nest together, with a first gap between the two elements. The trailing element overlaps the trailing edge of the intermediate element, with a second gap between the two elements. Airflow through the gaps improves the performance of the blade, by directing flow over each blade element to maintain the airflow attached, prevent stall, increase the pressure differential on opposite sides of the blade, and increase lift. As a result, the number of blades that contribute to the rotation of the turbine, generating lift sufficient to overcome drag, is greater than in prior designs. In another embodiment, a horizontal axis wind turbine includes one or more multi-element blades extending radially from a hub, to rotate about a horizontal axis.

In one embodiment, a vertical wind turbine includes a plurality of blades arranged in an annular path around a central axis of rotation. Each blade includes a first element and a second element. The first element has a concave rear surface, and the second element has a convex leading surface facing the concave rear surface. Each of at least 45% of the blades generates a lift in a direction of rotation of the turbine that is greater than a drag generated by the same blade.

In one embodiment, a vertical wind turbine includes a plurality of blades spanning a height of the turbine. Each blade is connected to the turbine at first and second opposite ends of the blade. The turbine also includes a generator assembly configured to convert a mechanical rotation of the turbine into electrical energy. The blades are arranged in an annular path around a central axis of rotation. Each blade has a leading element, an intermediate element, and a trailing element. The leading element has a concave trailing surface, and the intermediate element has a convex leading surface. The trailing surface of the leading element and the leading surface of the intermediate element face each other. The intermediate element and the trailing element have overlapping surfaces. The leading, intermediate, and trailing elements are dimensioned to provide a first gap between the leading element and the intermediate element and a second gap between the intermediate element and the trailing element. The plurality of blades generates a net positive rotation of the turbine with an incoming wind.

In one embodiment, a wind turbine includes a plurality of blades arranged around a central axis of rotation, and a generator assembly configured to convert a mechanical rotation of the turbine into electrical energy. Each blade has a first element and a second element that have complementary or nestable facing surfaces. The first and second elements are dimensioned to provide a gap between the first and second elements. The plurality of blades generates a net positive rotation of the turbine with an incoming wind.

In one embodiment, a horizontal wind turbine includes a plurality of blades arranged radially about a central axis of rotation. Each blade includes a first blade segment spanning an inner section of the turbine, and a second blade segment radially outside of the first blade segment and spanning an outer section of the turbine. The first blade segment of each blade is oriented at a first angle of attack, and the second blade segment of each blade is oriented at a second angle of attack that is different from the first angle of attack.

In summary the present invention provides multi-element airfoils (also referred to as “blades”) for a wind turbine which is vertical (i.e., rotates about a vertical axis) or horizontal (i.e., rotates about a horizontal axis) and to vertical and horizontal wind turbines incorporating such blades. In one exemplary embodiment a vertical wind turbine is provided including a plurality of airfoils arranged generally vertically along an annular path, wherein each airfoil includes a plurality of elements, wherein for each airfoil a slot is defined between consecutive elements wherein said slot is bounded by a surface of one of said consecutive elements and a surface the other of said consecutive elements. In another exemplary embodiment both of the surfaces of at least two of said consecutive elements generally curve in the same direction. In one exemplary embodiment each airfoil includes a leading element and a trailing element. In another exemplary embodiment each airfoil comprises a leading element, a trailing element and an intermediate element between the leading and trailing elements. In yet another exemplary embodiment, two of these elements convex surface opposite a concave surface. In a further exemplary embodiment, the leading and intermediate elements each comprise said convex surface opposite said concave surface.

In other exemplary embodiments, each airfoil includes four or more elements. In any of the aforementioned embodiments, each airfoil may be positioned along a radius of said vertical wind turbine, and each airfoil may be oriented at a predetermined angle of attack relative to its corresponding radius. Furthermore in any of the aforementioned embodiments, each airfoil may be oriented at the same angle of attack relative to its corresponding radius. Moreover, in any of the aforementioned embodiments, the angle of attack of each airfoil may be varied as function of each airfoil's orientation to a wind. In another exemplary embodiment incorporating a leading, intermediate and trailing element, two slots are defined between elements, a leading slot between the leading and intermediate elements, and a trailing slot between the intermediate element and trailing elements. In another exemplary embodiment each such slot includes a maximum width, wherein the maximum width of the leading slot is greater than the maximum width of the trailing slot. In any of the aforementioned embodiments, each airfoil may include a chord extending through each of its corresponding plurality of elements.

In another exemplary embodiment, each of the airfoils positioned within 260°, in a first direction from a wind, along said annular path and each of the airfoils positioned within 40° of said wind in an opposite direction around said annular path will generate a component of lift in a direction of rotation of said wind turbine that is greater than a drag generated by said airfoil in the same direction. In another exemplary embodiment, the plurality of airfoils are equidistantly arranged around the annular path, wherein at least 45% of all airfoils will generate a component of lift in a direction of rotation of said wind turbine that is greater than a drag generated by said same airfoils in the same direction. In yet another exemplary embodiment the plurality of airfoils are equidistantly arranged around the annular path wherein at least 88% of all airfoils will generate a component of lift in a direction of rotation of said wind turbine that is greater than a drag generated by said same airfoils in the same direction. In any of the aforementioned exemplary embodiments, each of the plurality of airfoils comprises a length and wherein each element spans said length.

In another exemplary embodiment, a vertical wind turbine is provided comprising a plurality of airfoils arranged generally vertically along an annular path, wherein each of the airfoils positioned within 260°, in a first direction from a wind, along said annular path and each of the airfoils positioned within 40° of said wind in an opposite direction around said annular path will generate a component of lift in a direction of rotation of said wind turbine that is greater than a drag generated by said airfoil in the same direction.

In further exemplary embodiment, a vertical wind turbine is provided including a plurality of airfoils arranged generally vertically along an annular path, wherein said plurality of airfoils are equidistantly arranged around the annular path, wherein at least 45% of all airfoils will generate a component of lift in a direction of rotation of said wind turbine that is greater than a drag generated by said same airfoils in the same direction.

In yet a further exemplary embodiment, a vertical wind turbine is provided including a plurality of airfoils arranged generally vertically along an annular path, wherein said plurality of airfoils are equidistantly arranged around the annular path wherein at least 88% of all airfoils will generate a component of lift in a direction of rotation of said wind turbine that is greater than a drag generated by said same airfoils in the same direction.

In yet another exemplary embodiment, a horizontal wind turbine is provided comprising a plurality of radially extending airfoils, wherein each airfoil comprises a plurality of elements arranged radially relative to each other, wherein said horizontal wind turbine is rotatable about a generally horizontal axis. In a further exemplary embodiment, the plurality of elements of each airfoil are spaced apart from each other. In yet another exemplary embodiment, each airfoil comprises a first and a second element, wherein the first element of each airfoil is at a different angle of attack than the second element of such airfoil. In yet another exemplary embodiment, the first element of each airfoil is mounted on at least a first band and the second element of each airfoil is mounted on at least a second band wherein the first band is within the second band. In a further exemplary embodiment, the angle of attack of the first and second elements of each airfoil is predetermined. In another exemplary embodiment, the angle of attack of each airfoil first element is the same. In a further exemplary embodiment, the angle of attack of each airfoil second element is the same.

### BRIEF DESCRIPTION OF THE DRAWINGS

FIG. 1 is a front view of a vertical wind turbine, according to an exemplary embodiment of the invention.

FIG. 2 is a perspective view of multi-element blades arranged for use in a vertical wind turbine, according to an exemplary embodiment of the invention.

FIG. 3 is a lower perspective view of a multi-element blade, according to an exemplary embodiment of the invention.

FIG. 4A is a non-sectional view of a multi-element blade, according to an exemplary embodiment of the invention.

FIG. 4B is a non-sectional view of a multi-element blade depicting air flow paths according to an exemplary embodiment of the invention.

FIG. 5A is a schematic top view of a vertical axis wind turbine with a plurality of multi-element blades, according to an exemplary embodiment of the invention.

FIG. 5B is a force diagram view of the vertical axis wind turbine of FIG. 5A.

FIG. 6 is a schematic top view of a vertical axis wind turbine with variable angles of attack, according to an exemplary embodiment of the invention.

FIG. 7A is a front view of a horizontal axis wind turbine according to an exemplary embodiment of the invention.

FIG. 7B is a partial side view of blade elements of a horizontal wind turbine.

FIG. 8 is a schematically depicted top view of a vertical wind turbine.

### DETAILED DESCRIPTION OF THE INVENTION

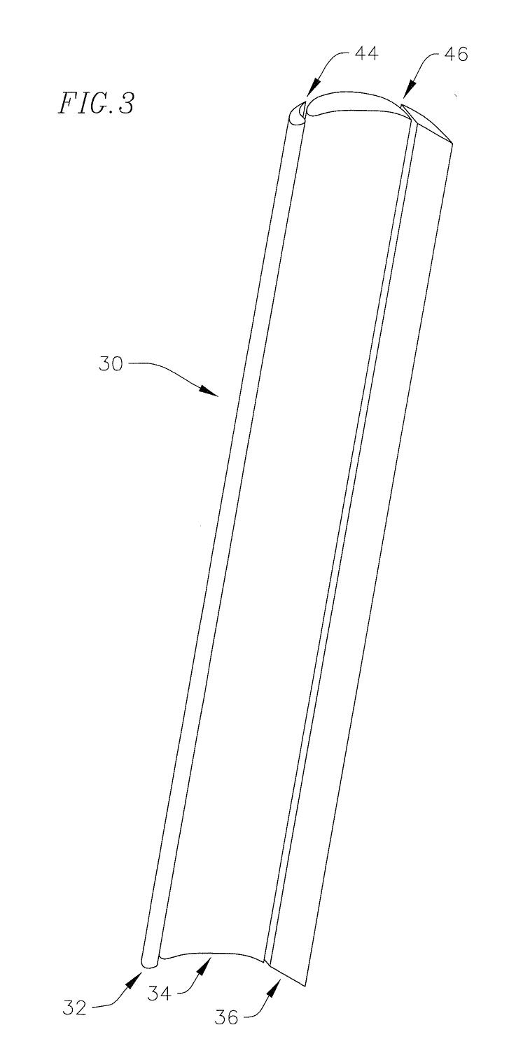

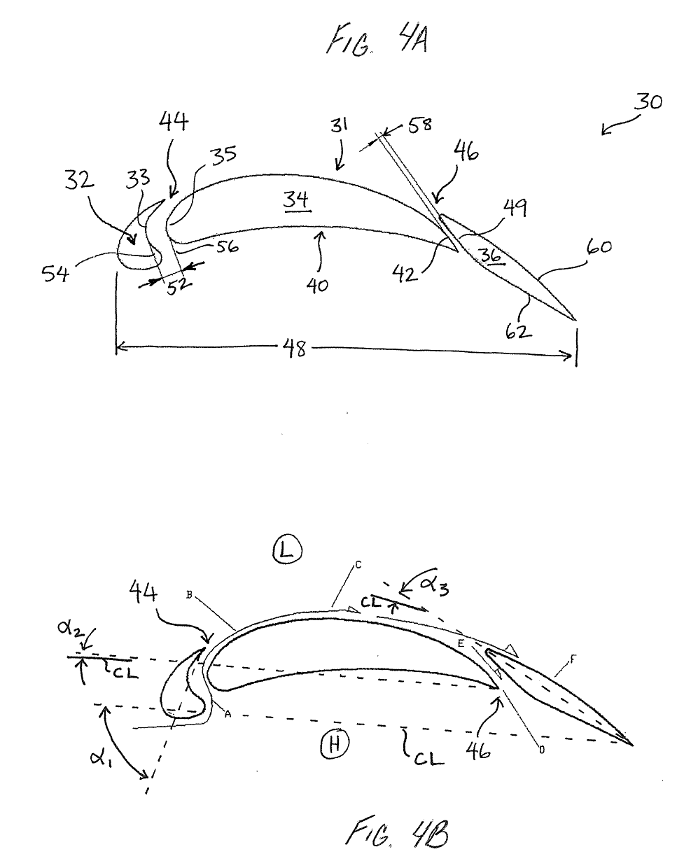

The present invention relates to wind turbines and more particularly to a multi-element airfoil for a vertical or horizontal axis wind turbine. In an exemplary embodiment, a multi-element airfoil, i.e. blade, is provided, for use with wind turbines that increase wind turbine efficiency significantly. For example, in one embodiment, a vertical axis wind turbine is provided with a plurality of multi-element blades arranged around a vertical axis. In an exemplary embodiment, the blades located within an arc from 0° to about 320° or 340° around the wind turbine generate lift sufficient to overcome the drag generated by such blades, for rotating the wind turbine for a given wind direction on the blades. In other words, only the airfoils located in an arc of about 20° to 40° generate insufficient lift to overcome their drag. In an exemplary embodiment, three-element airfoils 30 include three airfoil elements, namely a first element or a leading edge element 32, an intermediate element or a second element 34, and a trailing or a third element 36, as shown in FIGS. 3, 4A, and 4B, and described in further detail below. The multi-element blades may also be incorporated into a horizontal axis wind turbine, as described further below.

The inventive airfoil has been designed to maximize lift while minimizing the drag generated by the airfoil. To design an inventive multi-element airfoil, Computational Flow Dynamics Analysis (CFD) was used. Specifically, the CFD program created by Dr. Patrick Hanley was used to design the inventive airfoil. A description of the methods used to design the airfoils according to embodiments of the invention is also presented in Appendix A of the related U.S. Provisional Application No. 61/322,783.

The multi-element airfoil includes two or more airfoil elements in close proximity to each other, so that the multiple elements perform together as a single airfoil with better performance than a single airfoil element.

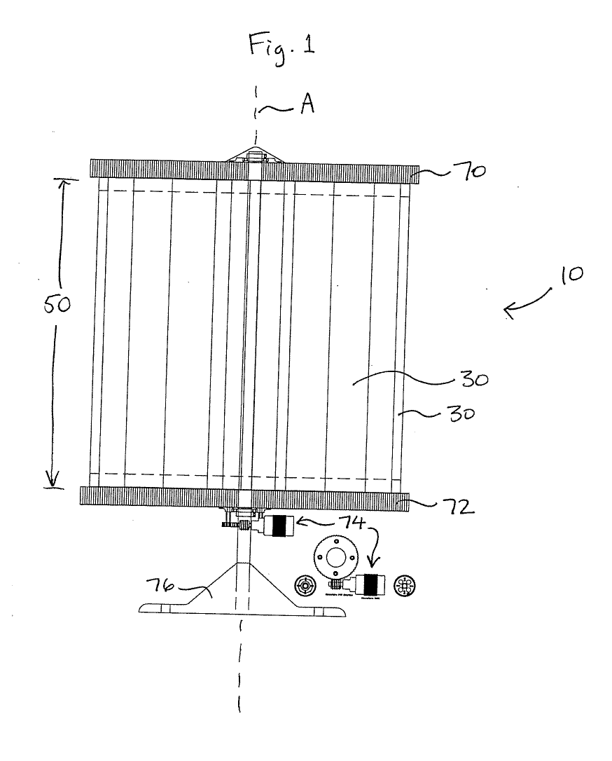

A vertical axis wind turbine 10 according to an embodiment of the invention is shown in FIG. 1. The wind turbine 10 includes a plurality of blades or airfoils 30 arranged annularly around a vertical axis A. The blades span a height 50 between upper and lower plates 70, 72. In one embodiment the blades are connected to the turbine only at their opposite ends at the plates 70. 72. The turbine is coupled to a generator assembly, identified at 74, which converts the mechanical rotation of the wind turbine into electrical energy. This electrical energy can be transmitted for immediate use or stored. The turbine includes a base 76. The turbine can be installed in any location available to a wind source, including on roofs of commercial and residential buildings, parking garages, and other structures, in urban and non-urban areas. Vertical axis wind turbines are often desired in these types of applications as they are clearly visible to birds, and they need not be pointed directly into the wind direction.

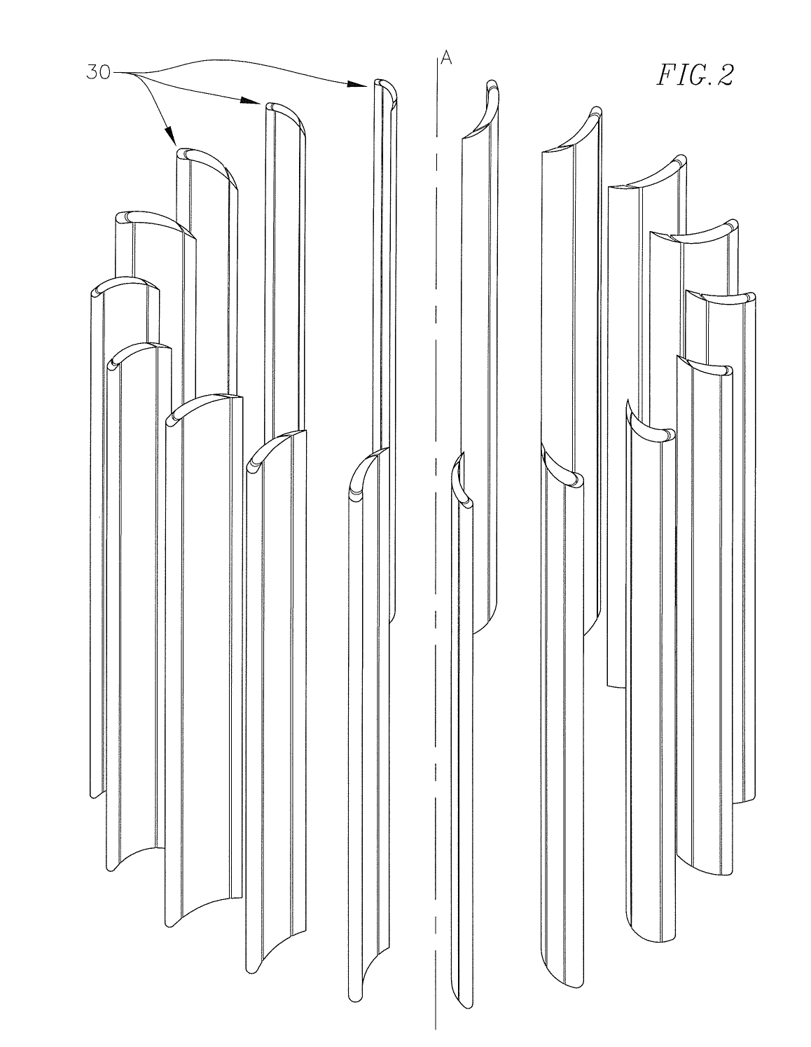

In an exemplary embodiment, the blades 30 are multi-element blades. An annular arrangement of multi-element blades 30 for use in a vertical axis wind turbine is shown in FIG. 2. In this embodiment, 18 blades are shown, although in other embodiments, more or fewer blades may be included in a vertical axis wind turbine. In one embodiment, the vertical axis wind turbine includes 18 blades, and in another embodiment 19 blades, and in another embodiment 20 blades. The blades are arranged in an annular path around a central axis of rotation A.

FIGS. 3 and 4 show a single multi-element airfoil or blade 30. In the shown exemplary embodiment, the airfoil 30 includes a first or leading edge element 32, a second or intermediate element 34, and a third or trailing element 36. The airfoil 30 has an upper convex surface 31 opposite a lower concave surface 40. As can be seen from FIG. 4A, in the exemplary embodiment, the three elements 32, 34, and 36 have mating or corresponding profiles. A slot or gap is defined between each pair of elements. A first or leading slot 44 is defined between the leading element 32 and the intermediate element 34. The leading slot 44 is defined between a concave rear surface 33 of the leading element 32 and a corresponding convex leading surface 35 of the intermediate element 34. These surfaces 33, 35 are complementary, such that the intermediate element 34 is nestable with the leading element 32. A second or trailing slot 46 is defined between the intermediate element 34 and the trailing element 36. The trailing element 36 overlaps the intermediate element 34, extending over a trailing edge 42 of the intermediate element 34. The trailing slot 46 is defined between this trailing edge 42 of the intermediate element 34 and a leading under surface portion 49 of the trailing element 36.

As can be seen, the convex leading surface 35 of the intermediate element 34 is generally complementary to the generally rear concave surface 33 of the leading element 32. The trailing element 36 includes two opposite generally convex surfaces 60, 62 with the leading portion 49 of the surface 62 being generally flat, as for example shown in FIG. 4A. In this regard, when the three elements are brought together, the intermediate element nests with the leading element, and the trailing element nests over the trailing edge portion of the intermediate element.

The airfoil 30 has a chord length 48 from the front of the first element 32 to the end of the third element 36. The chord length 48 of the entire airfoil and the length of each individual element is a function of the height 50 of the airfoil (FIG. 1). For a blade having a height of 36 inches, the airfoil has a leading element 32 having a chord length of 1.6 inches, an intermediate element 34 having a chord length of 6.4 inches, and a trailing element 36 having a chord length of 3.9 inches. In one embodiment, the vertical axis wind turbine 10 shown in FIG. 1 is approximately 3 feet in height 50 and approximately 3 feet in diameter. The turbine 10 may be scaled to other sizes, up to for example six feet by six feet. In one embodiment, where the combined multi-element blade is oriented at a zero angle of attack, the angle of attack α₁ of the leading element is −62°, the angle of attack α₂ of the intermediate element is 2°, and the angle of attack α₃ of the trailing element is 35°. That is, these are the angles of attack of each element relative to the chord of the combined multi-element blade. The angles α₁, α₂, and α₃ are shown in FIG. 4B, with reference to the chord line CL of the combined three-element blade. The dotted lines in FIG. 4B are approximations for illustration only.

As shown in FIG. 4A, the leading slot 44 has a width 52 measured perpendicularly between tangent 54 (taken at the lowest point of the concave surface 33 of the leading element 32) and tangent 56 (taken at the most leading point on the leading convex surface 35 of the intermediate element 34). The trailing slot 46 has a width 58 measured between two parallel lines extending from the leading under surface portion 49 of the trailing element 36 and the trailing edge 42 of the intermediate element 34. In one embodiment, the three elements of the airfoil do not contact each other, but are secured at their respective ends to the upper and lower plates 70, 72 (see FIG. 1).

The multi-element, nesting blade 30 improves the performance of the blade as compared to other blade configurations. The airflow through the gaps 44 and 46 is shown in FIG. 4B. Due to the air flow through these gaps and the interaction of the elements with each other, the three-element blade provides improved performance as compared to each individual element 32, 34, 36 on its own.

The leading element 32 works to delay stall by modifying the airflow at increased angles of attack. As the angle of attack increases, the airfoil becomes more likely to stall, resulting in a loss of lift. The leading element 32 delays this stall at increasing angles of attack, by providing flow to the intermediate element. This air flow is shown in FIG. 4B. As shown in FIG. 4B, below the airfoil 30 is a high pressure side H, and above the airfoil is a low pressure side L. High pressure air A from the leading element 32 is directed through the first gap 44 between the leading and intermediate elements 32, 34, from the high pressure side to the low pressure side, indicated at letter B. The air flow accelerates through the gap 44, and as a result the air C flowing over the top surface of the intermediate element is moving at a higher velocity at C than it would be if the leading element 32 were not present. The higher velocity air at C results in a lower pressure, which generates increased lift. This permits the angle of attack of the intermediate element to be higher than it otherwise could be. The passage of high pressure air from the lower surface controls the boundary layer on the upper surface.

It should be noted that the terms above, below, upper, and lower, and other similar terms are relative terms only, used for convenience to describe relative locations of components as shown in the figures, and are not intended to be limiting in an absolute sense.

The second gap 46 also contributes to improved performance. The low pressure air E at the top of the intermediate element 34 passes through the second gap 46 between the intermediate element 32 and the trailing element 34. This air flow creates a low pressure region at the trailing edge of the intermediate element, as indicated at letter D. This low pressure region creates a vacuum through the second gap 46, which helps to keep the airflow on the top side attached as it transitions onto the trailing element 36, at letter F. The second gap 46 pulls air from the trailing edge top side of the intermediate element 34 toward the gap at E, preventing separation from the airfoil contour, and thus preventing the airfoil from stalling.

Finally, the trailing element 36 provides increased lift by increasing the camber of the airfoil, without detaching the airflow. The increased camber increases the pressure differential between the top and bottom surfaces of the airfoil, directs the air flow downward, and provides increased lift.

The nesting configuration of the three elements, with the surfaces 33, 35 at gap 44 and the surfaces 42, 49 at gap 46 (see FIG. 4A), provides the desired airflow through the gaps 44, 46 and the resulting improved performance.

The gaps or slots 44 and 46 are sized for maximum efficiency, as described in further detail in Appendix B of the related provisional application, No. 61/322,783. Appendix B from that application is incorporated herein by reference. The size of the gaps is important as it defines the spacing between the airfoil elements. Spacing that is too large allows the individual airfoil elements of the multi-element airfoil to begin acting as individual single elements, rather than one combined element. Spacing that is too small blocks airflow through the gaps. In one embodiment, for a three-element airfoil, the width 52 of the leading slot is about 0.45 inches, and the width 58 of the trailing slot is about 0.11 inches. In one embodiment, the maximum width of the first slot 44 is larger than the maximum width of the second slot 46.

Additionally, the size of the gaps is affected as the airfoil and the individual elements are scaled up or down in size. If the blade (and its elements) is scaled by 25%, the leading slot can be scaled between 22% to 55%, and the trailing slot can be scaled between 19% to 33%. For example, if the blade is scaled by 400%, the leading slot may be scaled by 296% to 488%, and the trailing slot may be scaled by 324% to 996%. Further detailed analysis of the scaling of the slots in relation to the scaling of the blades is shown in Attachment G of the related provisional application, No. 61/322,783. Attachments A-G from that application are incorporated herein by reference.

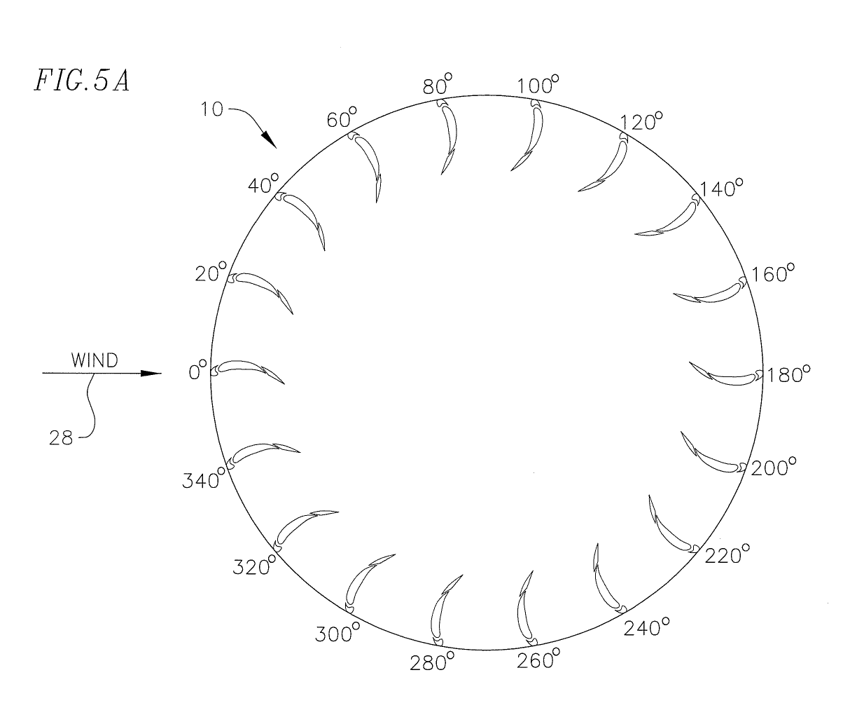

An annular arrangement of three-element blades for use in a vertical axis wind turbine 10 is shown in FIGS. 5A-5B. In the embodiment shown, 18 blades are included, and are arranged equidistantly around the annular path, spaced apart from each other by 20°. The wind direction is indicated in each figure, on the left side of the page.

FIG. 5B shows a schematic view with the net force on each blade. The net force is a result of the lift generated by the blade from the wind 28. The lift generated by the blades produces a net clockwise rotation of the turbine. In the embodiment shown in FIG. 5B, 16 of the 18 blades contribute to this clockwise rotation. That is, 16 of the blades contribute a net lift in the direction of clockwise rotation, generating sufficient lift to overcome drag. Relative to the wind speed direction (at 0°), these blades are located in an arc spanning from 40° in one direction through 260° in the opposite direction, spanning a total arc of 300°. The remaining two blades, located at positions 280° and 300° as shown in FIG. 5B, produce insufficient lift to overcome drag at this wind direction. These two blades produce a net force in the counter-clockwise direction of rotation, thus contributing drag to the wind turbine's clockwise rotation.

The net force acting on each blade is due to the forces applied to the blade from the wind 28. The net force on the turbine is due to the pitching moment created by the force on each blade with respect to the central axis of rotation of the turbine. The three-element blade 30 is designed to create a net force closer to the leading edge of the blade than the trailing edge, thus producing a greater pitching moment on the turbine. For the three-element blade 30, the lowest pressure region is located at approximately ¼ of the chord length 48 (see FIG. 4A) from the leading edge. This is known as the center of pressure for the blade. The forward-located center of pressure, closer to the leading edge than the trailing edge of the blade, contributes to additional torque on the turbine 10, contributing to the clockwise rotation.

As shown in FIG. 5B, the lift generated by the 18 blades at the center of pressure of each blade causes a net clockwise rotation of the turbine about its central vertical axis. In one embodiment, blades within an arc of about 300° contribute to this rotation, generating lift sufficient to overcome drag in the direction of rotation. Blades that do not contribute to this rotation are confined to an arc of about 60°. Thus, in one embodiment, at least 80% of the blades in a vertical axis wind turbine contribute to the positive rotation of the turbine, and in another embodiment at least 60%, and in another embodiment at least 45%. In one embodiment about 88% or up to 88% of the blades contribute to the positive rotation of the turbine. In one embodiment, the turbine includes about 300° of positive rotation or lift, and about 60° of negative rotation or drag.

As can be seen in the exemplary embodiment, the blades mounted on the vertical wind turbine are able to generate at least a component of lift in a direction of rotation that is greater than the drag generated in a direction of rotation, even when located up to 260° away from the wind in a first direction and 40° away from the wind in a second direction opposite the first direction (see for example Diagrams 15-52 in Appendix A). With this exemplary embodiment, only airfoils located within an arc less than 60° are not capable of generating a lift component in a direction of rotation that is greater than the drag component in such a direction of rotation. As such, vertical wind turbines incorporating the exemplary embodiment of multi-element airfoils are able to provide more lift for rotating the vertical wind turbine, thereby increasing the efficiency of the wind turbine.

According to one embodiment of the invention, a vertical axis wind turbine including multi-element blades as disclosed herein, with blades approximately 3 feet in height 50, can generate about 4 kilowatts at a wind speed of 28 miles per hour. The output of the turbine depends in part on the size and weight of the blades. The blades may range in weight from about 0.8 pounds (per blade) to about 3 pounds. In one embodiment, the blades are made from composite materials.

According to one embodiment of the invention, a vertical axis wind turbine with three-element blades was tested to determine the power generated and the efficiency of the turbine at various airspeeds. The turbine was tested with blade configurations of 9 to 20 blades at angles of attack of −45° to +45° (at various blade and degree increments). The turbine had a blade height of 3 feet and a diameter of 3 feet. To conduct the test, the turbine was mounted to a vehicle which was driven along a straight path at speeds of 5, 10, 15, 20, 25, and 30 miles per hour. Wind speed, RPM, and turbine efficiency were recorded for each blade configuration at each speed. Analysis of the resulting data showed that the highest RPM (174 rpm) was produced by the turbine with 20 blades at a +3° angle of attack at 30 miles per hour. The highest calculated wattage output (4.3 kilowatts) was produced by the same turbine. The turbine with 18 blades at +3° angle of attack produced the highest efficiency (about 69%), and the turbine with 20 blades at +3° angle of attack produced the second-highest efficiency (about 67%).

Accordingly, in one embodiment, a vertical axis wind turbine is provided with 20 blades at a +3° angle of attack. In another embodiment, a vertical axis wind turbine is provided with 19 blades at a +3° angle of attack. In another embodiment, a vertical axis wind turbine is provided with 18 blades at a +3° angle of attack.

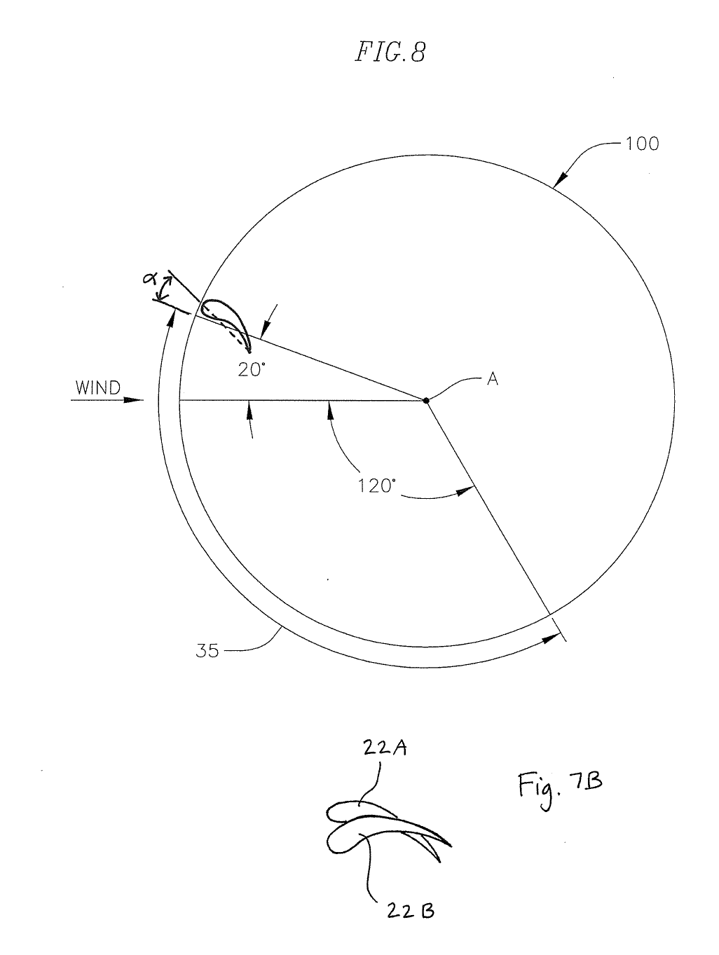

As used herein, the angle of attack a of a blade refers to the angle of the chord with respect to the radius from the blade to the central axis of rotation of the turbine, as shown for example in FIG. 8.

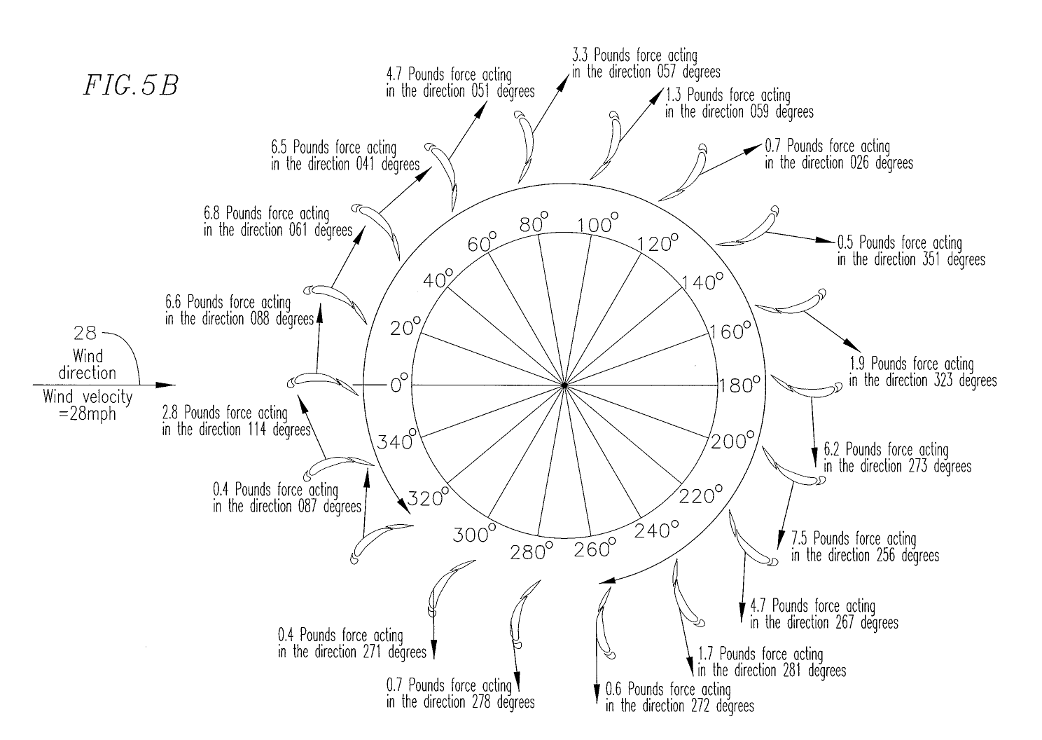

In one embodiment, the angle of attack of each blade in the annular path is the same as the other blades. In another embodiment, the angle of attack of each airfoil may be varied as function of each airfoil's orientation to the incoming wind, as shown for example in FIG. 6. This system may be referred to as a variable pitch system. As the airfoils rotate around the vertical axis, the airfoils may be rotated along their own longitudinal axis to adjust the angle of attack of the airfoil. For a multi-element airfoil, the angle of attack refers to the average angle of attack across the multiple elements of the airfoil. In FIG. 6, the angle of attack of the airfoils is adjusted according to the airfoil's rotational position around the vertical axis turbine. Each blade can be independently controlled to adjust the angle of attack as the blade rotates around the turbine. As the blades rotate, the angle of attack of the blade varies according to the circumferential position of the blade in the annular path. This design can improve the efficiency and performance of the turbine, reducing the drag caused by the blade as they rotate around the vertical axis of the turbine.

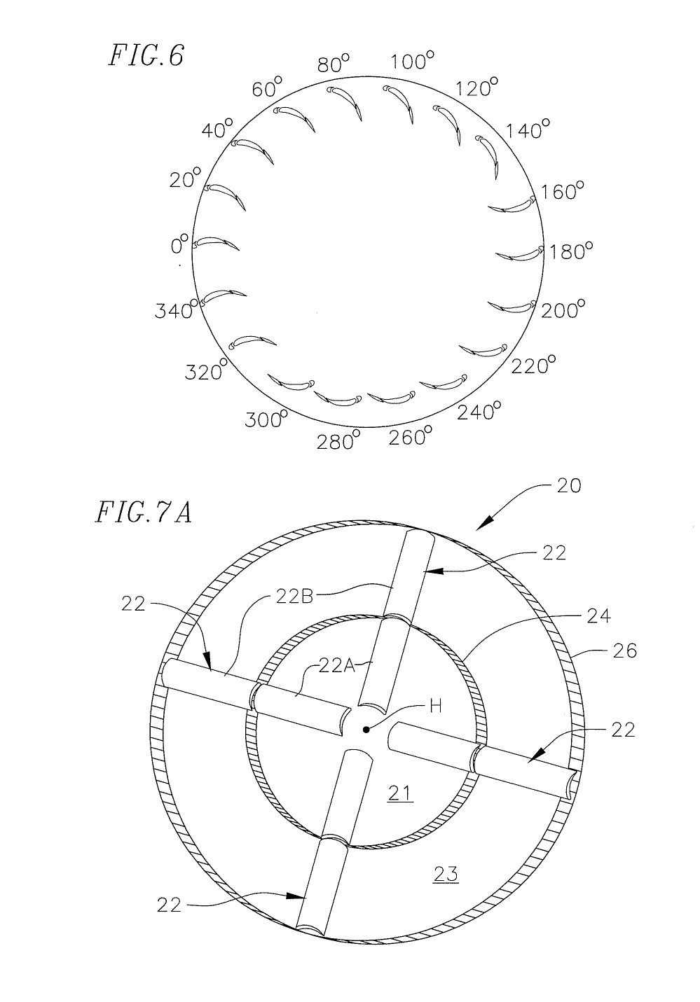

In another exemplary embodiment, multi-element blades may be used in a horizontal wind turbine, as shown for example in FIGS. 7A-B. FIG. 7A shows a horizontal axis wind turbine 20 with four blades 22 that span radially and rotate about a horizontal axis H. In this embodiment, the wind turbine includes a first band or section 21 between the central axis and a first inner ring 24, and a second band or section 23 between the ring 24 and a second outer ring 26. Each blade includes an inner blade segment 22A spanning across the first band, from the hub (not shown) to the first ring 24, and an outer blade segment 22B spanning across the second band, from the first ring 24 to the second ring 26. The blade segments may each be separated by a gap, at the corresponding ring. Each of the inner and outer blades 22A, 22B may be a multi-element blade, for example, a two-element blade including a leading and a trailing element, or a three-element blade including a leading element, an intermediate element, and a trailing element. In other embodiments, each of the inner and outer blades 22A, 22B may be a single-element blade. The inner blades 22A may be configured at a first angle of attack, and the outer blades 22B may be configured at a second, different angle of attack, as shown for example in the partial side view of FIG. 7B. The outer blades rotate at a faster rotational velocity than the inner blades, and thus the segmented system enables the outer blades to be oriented at a different angle of attack than the inner blades, to improve efficiency. In one embodiment, the outer blades are oriented at a lower angle of attack than the inner blades. For example, the outer blades may be oriented at an angle of attack of about 3° and the inner blades at about 10°.

In one exemplary embodiment, the horizontal axis wind turbine is provided with a number of bands equal to the number of blade segments. For example, a two-element horizontal axis wind turbine includes two bands, an outer band and an inner band. The blades may be connected at the center to a hub (not shown). The first segment of the blades extends from the hub to the first band. The second segment of the blades is connected to the second band and extends between the second band and the third band. Each blade segment may have multiple elements, with gaps between the elements, as described above. Airfoils may have different profiles or may be the same profiled airfoils but arranged in a different angles of attack relative to each other.

As can be seen the invention has been described by way of exemplary embodiments and analysis has been provided for such embodiments. However, the invention is not limited to such embodiments. The invention in alternate embodiments may include airfoils comprising two or more blades and vertical wind turbines comprising such airfoils. These airfoils may be arranged in a vertical wind turbine as described above in relation to the three element airfoils. In one exemplary embodiment, each airfoil may include only two elements. In another embodiment, each airfoil includes two or more elements and at least two elements of each airfoil have a convex surface opposite a concave surface. In one exemplary embodiment only two elements have a convex surface opposite a concave surface.

What is claimed is:

1. A vertical wind turbine, comprising:
a plurality of blades arranged in an annular path around a central axis of rotation;
wherein each blade comprises a first element and a second element, the first element comprising a concave rear surface, and the second element comprising a convex leading surface facing the concave rear surface,
wherein each of at least 45% of the blades generates a lift in a direction of rotation of the turbine that is greater than a drag generated by the same blade.

2. The vertical wind turbine of claim 1, wherein each blade further comprises a third element overlapping a trailing edge of the second element.

3. The vertical wind turbine of claim 2, further comprising a first slot between the first element and the second element, and a second slot between the second element and the third element.

4. The vertical wind turbine of claim 2, wherein relative to the blade, the first element is positioned at an angle of attack of −62°, the second element is positioned at an angle of attack of 2° , and the third element is positioned at an angle of attack of 35°.

5. The vertical wind turbine of claim 2, wherein each blade comprises a leading edge at a front end of the first element and a trailing edge at a rear end of the third element, and wherein a center of pressure of the blade is located closer to the leading edge of the blade than the trailing edge of the blade.

6. The vertical wind turbine of claim 1, wherein greater than 80% of the blades contribute to a positive rotation of the turbine.

7. The vertical wind turbine of claim 1, wherein the plurality of blades comprises at least 18 blades.

8. The vertical wind turbine of claim 1, wherein each blade is oriented at an angle of attack, and wherein the angle of attack is varied according to a circumferential position of the blade in the annular path.

9. The vertical wind turbine of claim 1, wherein each blade is oriented at an angle of attack, and wherein the angle of attack of each blade is the same.

10. The vertical wind turbine of claim 1, wherein each of the blades positioned within an arc of 260° along the annular path in a first direction from a wind, and each of the blades positioned within an arc of 40° along the annular path in an opposite second direction from the wind generate a lift in a direction of rotation of the turbine that is greater than a drag generated by the same blade.

11. The vertical wind turbine of claim 1, wherein the blades are equidistantly arranged around the annular path, and wherein at least 60% of the blades generate a lift in a direction of rotation of the turbine that is greater than a drag generated by the same blade.

12. The vertical wind turbine of claim 1, wherein the blades are equidistantly arranged around the annular path, and wherein at least 80% of the blades generate a lift in a direction of rotation of the turbine that is greater than a drag generated by the same blade.

13. The vertical wind turbine of claim 1, wherein the blades are equidistantly arranged around the annular path, and wherein about 88% of the blades generate a lift in a direction of rotation of the turbine that is greater than a drag generated by the same blade.

14. The vertical wind turbine of claim 1, wherein the blades are equidistantly arranged around the annular path.

15. A vertical wind turbine, comprising:
a plurality of blades spanning a height of the turbine, each blade connected to the turbine at first and second opposite ends of the blade; and
a generator assembly configured to convert a mechanical rotation of the turbine into an electrical energy,
wherein the blades are arranged in an annular path around a central axis of rotation,
wherein each blade comprises a leading element, an intermediate element, and a trailing element, the leading element having a concave trailing surface and the intermediate element having a convex leading surface, wherein the trailing surface of the leading element and the leading surface of the intermediate element face each other, and the intermediate element and the trailing element having overlapping surfaces,
wherein the leading, intermediate, and trailing elements are dimensioned to provide a first gap between the leading element and the intermediate element and a second gap between the intermediate element and the trailing element, and
wherein the plurality of blades generates a net positive rotation of the turbine with an incoming wind.

16. The vertical wind turbine of claim 15, wherein relative to the blade, the leading element is positioned at an angle of attack of −62°, the intermediate element is positioned at an angle of attack of 2°, and the trailing element is positioned at an angle of attack of 35°.

17. The vertical wind turbine of claim 15, wherein each gap comprises a maximum width, and wherein the maximum width of the first gap is larger than the maximum width of the second gap.

18. The vertical wind turbine of claim 15, wherein each of the blades positioned within an arc of 260° along the annular path in a first direction from a wind, and each of the blades positioned within an arc of 40° along the annular path in an opposite second direction from the wind generate a lift in a direction of rotation of the turbine that is greater than a drag generated by the same blade.

19. A wind turbine comprising:
a plurality of blades arranged around a central axis of rotation; and
a generator assembly configured to convert a mechanical rotation of the turbine into an electrical energy,
wherein each blade comprises a first element and a second element, the first and second elements having complementary facing surfaces,
wherein the first and second elements are dimensioned to provide a gap between the first and second elements, and
wherein the plurality of blades generates a net positive rotation of the turbine with an incoming wind.

20. The wind turbine of claim 19, wherein the central axis of rotation is generally vertical, and wherein the blades are arranged in an annular path around the axis of rotation.

21. The wind turbine of claim 19, wherein the central axis of rotation is generally horizontal, and wherein the blades are arranged radially around the axis of rotation.

22. The wind turbine of claim 21, wherein each blade comprises a first blade segment in a first band of the turbine and a second blade segment in a second band of the turbine.

23. The wind turbine of claim 22, wherein the first blade segment is oriented at a first angle of attack, and the second blade segment is oriented at a second angle of attack different from the first angle of attack.

24. A horizontal wind turbine comprising:
a plurality of blades arranged radially about a central axis of rotation;
wherein each blade comprises a first blade segment spanning an inner section of the turbine, and a second blade segment radially outside of the first blade segment and spanning an outer section of the turbine,
wherein the first blade segment of each blade is oriented at a first angle of attack, and the second blade segment of each blade is oriented at a second angle of attack that is different from the first angle of attack.

25. The horizontal wind turbine of claim 24, wherein the inner section is located between the central axis and a first ring, and the outer section is located between the first ring and a second ring.

26. The horizontal wind turbine of claim 24, wherein the blade segments each comprise a multi-element blade.
